(19) United States
(12) Patent Application Publication
(10) Pub. No.: US 2006/0230263 A1
(43) Pub. Date: Oct. 12, 2006

(54) Method and apparatus to guarantee configuration settings in remote data processing systems

(75) Inventors: Kulvir Singh Bhogal, Fort Worth, TX (US); Alexandre Polozoff, Bloomington, IL (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 11/104,258

(22) Filed: Apr. 12, 2005

(51) Int. Cl. G06F 1/24

(52) U.S. Cl. 713/100

(57) ABSTRACT

An improved method, apparatus, and computer instructions for updating configuration settings. In response to starting an application server in the data processing system, a messaging system is contacted to determine whether a configuration change occurred while the application server was unavailable. Configuration data is received to implement the configuration change in response to a determination that the configuration change occurred, wherein the configuration setting for the application server are updated.

### BACKGROUND OF THE INVENTION

1. Technical Field

The present invention relates generally to a data processing system, and in particular to a method, and apparatus for processing data. Still more particularly, the present invention provides an improved method, apparatus, and computer instructions for updating configuration settings in a data processing system.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretariats of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

The Internet also is widely used to transfer applications to users using browsers. With respect to commerce on the Web, individual consumers and business use the Web to purchase various goods and services. In offering goods and services, some companies offer goods and services solely on the Web while others use the Web to extend their reach.

These Websites are hosted on server data processing systems. Often times, more than one server data processing system supports transactions or request directed to a single Website. In other words, for a particular URL to a Website, more than one server data processing system is available to handle requests from users on the Web. These server data processing systems are often organized onto a grouping referred to as a cluster or server cluster. A cluster is a group of server data processing systems that provides fault tolerance and/or load balancing. If one server data processing system in the cluster fails, one or more additional server data processing systems are still available. Load balancing distributes the workload over multiple data processing system in the cluster.

These server data processing systems run applications used to handle requests. For example, the applications for a Website may include applications used to provide information about goods and services, provide a shopping cart, and process orders. Updates to these applications are often made to ensure that the applications and information provided by the applications are up to date. These updates may include, for example, configuration changes. One example of a configuration change is a change to data sources associated with a server cluster. Any servers in server data processing systems that are down, out of service, or otherwise unavailable when a configuration change occurs will be out of synchronization with the rest of the cluster in terms of the configuration settings.

As a result, errors may occur when requests are handled by a server that is out of synchronization with the rest of the cluster. These errors may include, for example, providing incorrect information regarding goods and services that are offered. Another error, for example, is a “data source not found” error. Currently, these server data processing systems remain out of synchronization until a forced resynchronization of the cluster occurs. These resynchronizations require manual intervention by an administrator for the cluster. Further, for this process to occur someone must be aware that the server data processing system is now available.

Therefore, it would be advantageous to have an improved method, apparatus, and computer instructions for guaranteeing synchronization of configuration settings in a set of data processing systems.

### SUMMARY OF THE INVENTION

The present invention provides an improved method, apparatus, and computer instructions for updating configuration settings. In response to starting an application server in the data processing system, a messaging system is contacted to determine whether a configuration change occurred while the application server was unavailable. Configuration data is received to implement the configuration change in response to a determination that the configuration change occurred, wherein the configuration setting for the application server are updated.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a diagram of a server cluster in accordance with a preferred embodiment of the present invention;

FIG. 3 is a block diagram of a data processing system that may be implemented as a server in accordance with a preferred embodiment of the present invention;

FIG. 4 is a block diagram illustrating a data processing system in which the present invention may be implemented;

FIG. 5 is a diagram of components used to guarantee that configuration settings in data processing systems are up to date in accordance with a preferred embodiment of the present invention;

FIG. 6 is a flowchart of a process for identifying configuration changes using a durable subscription in accordance with a preferred embodiment of the present invention;

FIG. 7 is a flowchart of a process for checking for configuration changes upon startup in accordance with a preferred embodiment of the present invention;

FIG. 8 is a flowchart of a process for announcing configuration changes in accordance with a preferred embodiment of the present invention; and

FIG. 9 is a flowchart of a process for resending messages in accordance with a preferred embodiment of the present invention.

### DETAILED DESCRIPTION OF THE PREFERRED EMBODIMENT

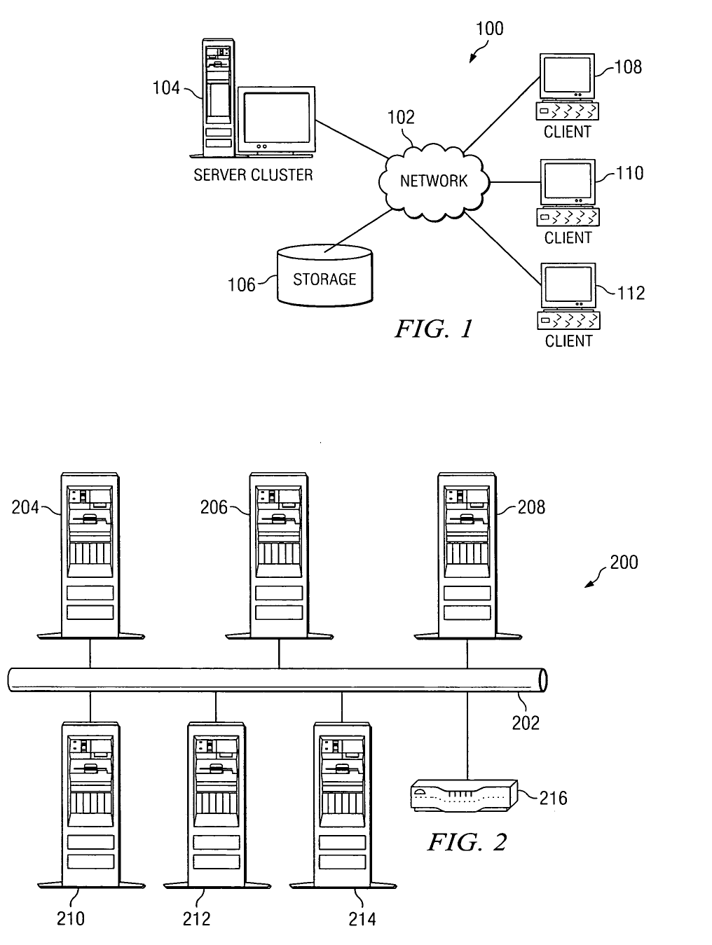

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communications links between various devices and computers connected together within network data processing system 100. Network 102 may include connections, such as wire, wireless communication links, or fiber optic cables.

In the depicted example, server cluster 104 is connected to network 102 along with storage unit 106. In addition, clients 108, 110, and 112 are connected to network 102. These clients 108, 110, and 112 may be, for example, personal computers or network computers. In the depicted example, server cluster 104 provides data, such as boot files, operating system images, and applications to clients 108-112. Clients 108, 110, and 112 are clients to server cluster 104. Network data processing system 100 may include additional servers, clients, and other devices not shown. In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

FIG. 2 is a diagram of a server cluster in accordance with a preferred embodiment of the present invention. Server cluster 200 contains fabric 202, which may be, for example, a bus, an Ethernet network, or some other interconnect system. Server data processing systems 204, 206, 208, 210, 212, and 214 connects to fabric 202 in server cluster 200.

Traffic scheduler 216 connects to fabric 202 and initially receives all incoming traffic to server cluster 200. Traffic scheduler 216 may take the form of a router. Although shown as a separate physical component, traffic scheduler 216 may be a logical construct distributed through one or more servers in server cluster 200.

An initial request from a client is received by traffic scheduler 216. Load balancing algorithms and/or other policies may be used to direct this initial request to one of the servers in server cluster 200. Traffic scheduler 216 handles subsequent requests by traffic scheduler 216. Alternatively, these requests may be handled directly from the server through which a session is initiated. A session, also referred to as a user session, is the session of activity that a user with a unique IP address spends on a Website during a specified period of time

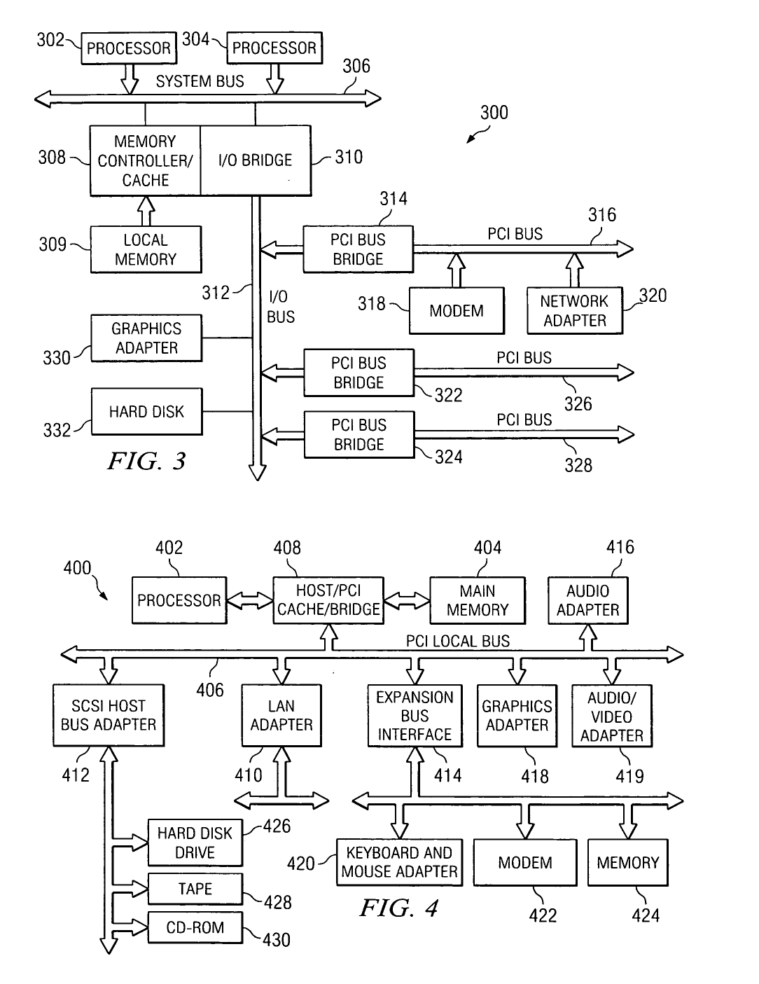

Next, FIG. 3 is a block diagram of a data processing system that may be implemented as a server, such as server 104 in FIG. 1, in accordance with a preferred embodiment of the present invention. Data processing system 300 may be implemented as a server data processing system, such as server data processing system 204 in server cluster 200 in FIG. 2. This system also may be used to implement traffic scheduler 216. Data processing system 300 may be a symmetric multiprocessor (SMP) system including a plurality of processors 302 and 304 that connects to system bus 306. Alternatively, a single processor system may be employed. Also, memory controller/cache 308 connects to system bus 306, which provides an interface to local memory 309. I/O Bus Bridge 310 connects to system bus 306 and provides an interface to I/O bus 312. Memory controller/cache 308 and I/O Bus Bridge 310 may be integrated as depicted.

Peripheral component interconnect (PCI) bus bridge 314 connects to I/O bus 312 and provides an interface to PCI local bus 316. A number of modems may be connected to PCI local bus 316. Modem 318 and network adapter 320 provide communications links to clients 108-112 in FIG. 1. These components connect to PCI local bus 316 through add-in connectors.

Additional PCI bus bridges 322 and 324 provide interfaces for additional PCI local buses 326 and 328, from which additional modems or network adapters may be supported. In this manner, data processing system 300 allows connections to multiple network computers. A memory-mapped graphics adapter 330 and hard disk 332 connect to I/O bus 312 as depicted, either directly or indirectly.

Those of ordinary skill in the art will appreciate that the hardware depicted in FIG. 3 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 3 may be, for example, an IBM eServer pSeries system, a product of International Business Machines Corporation in Armonk, N.Y., running the Advanced Interactive Executive (AIX) operating system or LINUX operating system.

FIG. 4 is a block diagram illustrating a data processing system in which the present invention may be implemented. Data processing system 400 is an example of a client computer. Data processing system 400 employs a peripheral component interconnect (PCI) local bus architecture. Although the depicted example employs a PCI bus, other bus architectures such as Accelerated Graphics Port (AGP) and Industry Standard Architecture (ISA) may be used. Processor 402 and main memory 404 connect to PCI local bus 406 through PCI Bridge 408. PCI Bridge 408 also may include an integrated memory controller and cache memory for processor 402. In the depicted example, local area network (LAN) adapter 410, small computer system interface (SCSI) host bus adapter 412, and expansion bus interface 414 connect to PCI local bus 406 by direct component connection. In contrast, audio adapter 416, graphics adapter 418, and audio/video adapter 419 connect to PCI local bus 406 by add-in boards inserted into expansion slots. Expansion bus interface 414 connects to a keyboard and mouse adapter 420, modem 422, and additional memory 424. SCSI host bus adapter 412 connects to hard disk drive 426, tape drive 428, and CD-ROM drive 430.

An operating system runs on processor 402 and coordinates and provides control of various components within data processing system 400 in FIG. 4. The operating system may be a commercially available operating system, such as Windows XP, which is available from Microsoft Corporation. An object oriented programming system such as Java may run in conjunction with the operating system and provide calls to the operating system from Java programs or applications executing on data processing system 400. “Java” is a trademark of Sun Microsystems, Inc. Storage devices contain instructions for the operating system, the object-oriented programming system, and applications or programs, these storage devices are for example, hard disk drive 426. Processor 402 loads these instructions into main memory 404 for execution.

Those of ordinary skill in the art will appreciate that the hardware in FIG. 4 may vary depending on the implementation. Other internal hardware or peripheral devices, such as flash read-only memory (ROM), equivalent nonvolatile memory, or optical disk drives and the like, may be used in addition to or in place of the hardware depicted in FIG. 4. Also, the processes of the present invention may be applied to a multiprocessor data processing system.

The depicted example in FIG. 4 and above-described examples are not meant to imply architectural limitations. For example, data processing system 400 also may be a notebook computer or hand held computer in addition to taking the form of a PDA. Data processing system 400 also may be a kiosk or a Web appliance.

The present invention provides an improved method, apparatus, and computer instructions for updating and synchronizing server data processing systems in a cluster. This cluster also is referred to as a cell with the different data processing systems in the cell being referred to as nodes. When an application server process starts, this process contacts a messaging system to determine whether a configuration change occurred while the application server process was unavailable. If a configuration change occurred while the server process was unavailable, the application server process receives configuration data to implement the configuration change so that the configuration settings for the application server process are updated.

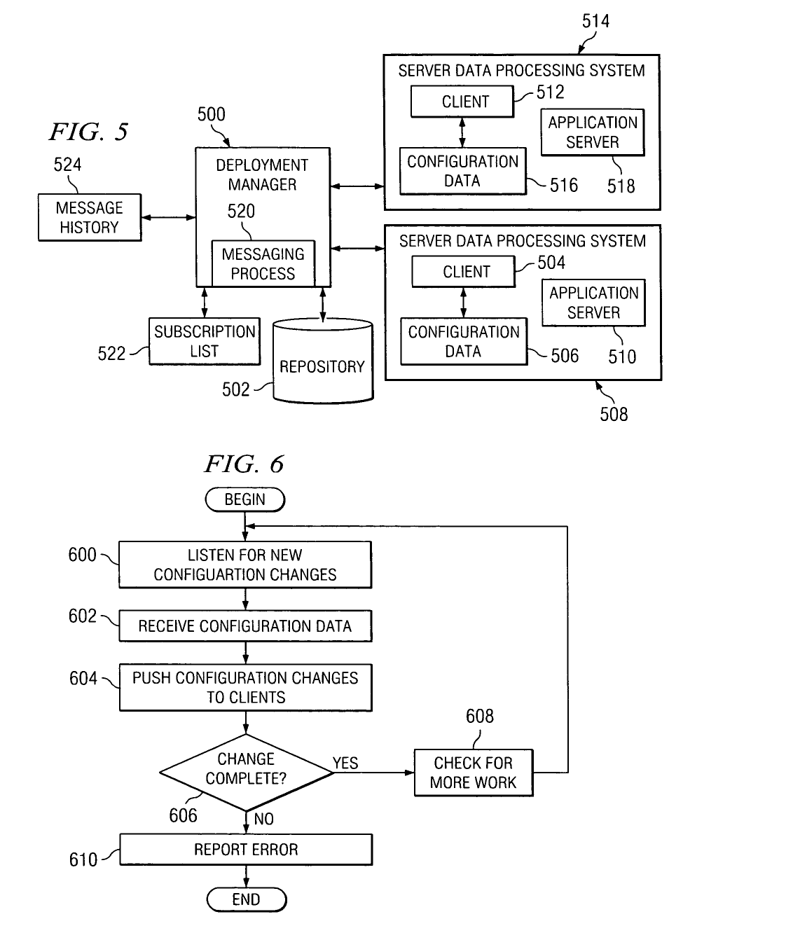

FIG. 5 is a diagram of components used to guarantee that configuration settings in data processing systems are up-to-date in accordance with a preferred embodiment of the present invention. In this illustrative example, deployment manager 500 is employed to distribute configuration updates as well as other updates to server data processing systems. Repository 502 contains the updates in these examples. In particular, client 504 may receive configuration updates from deployment manager 500 to update configuration settings 506. These two components are located within server data processing system 508. Configuration settings 506 contain settings used by application server 510. Application server 510 handles traffic received from remote data processing systems and uses configuration settings 506.

In a similar fashion, client 512 in server data processing system 514 may receive configuration updates from deployment manager 500 to update configuration settings 516. In these examples, application server 518 is a process within server data processing system 514 that handles traffic, such as requests from browsers located on remote data processing systems. Server data processing system 508 and server data processing system 514 are located in a server cluster, such as server cluster 200 in FIG. 2.

In these illustrative examples, deployment manager 500 sends updates to server data processing system 508 and server data processing system 514. Previously, if one of these server data processing systems were down or out of service or uncontactable when deployment manager 500 deploys a configuration update, that server data processing system was out of synchronization with the other server data processing systems. In this illustrative example, server data processing system 508 is unavailable when a configuration update, changing configuration settings for the cluster, is announced. Thus, server data processing system 508 does not have the most up-to-date settings in its configuration settings 506. This situation previously required a forced resynchronization that was initiated by an administrator.

The mechanism of the present invention implements messaging process 520 within deployment manager 500 to send notifications of configuration changes to server data processing systems 508 and 514. Messaging process 520 is part of a durable subscriber system in which the messaging system saves messages published or sent while a subscriber is disconnected or is otherwise unavailable. Messaging process 520 delivers these messages when the subscriber reconnects to the messaging system. A connected subscriber acts the same whether its subscription to the messaging system is durable or nondurable. The difference is how the messaging system acts when the subscriber is unavailable.

Deployment manager 500 identifies server data processing systems 508 and 514 using subscription list 522. List 522 identifies the different data processing systems that are to receive notifications of updates, such as configuration changes from repository 502. In the illustrative examples, all of the servers in a cluster in subscription list 522 are systems that all receive the same notification for a configuration update. Clients, such as client 504 in server data processing system 508 and client 512 in server data processing system 514 are configured to receive these notifications from messaging process 520. These clients send a response or acknowledgement to messaging process 520 when the notification is received from messaging process 520.

For example, if server data processing system 508 is unavailable and does not return a reply to a notification, deployment manager 500 places the identification of that server data processing system and the undelivered message into message history 524. When server data processing system 508 becomes available again, client 504 announces its presence to messaging process 520. The mechanism of the present invention in a client, such as client 504, directs this announcement to the messaging system in these examples. This announcement may be, for example, a message sent by client 504 to messaging process 520 to announce that server data processing system 508 is now present. Alternatively, some other type of connection may be made between client 504 and messaging process 520.

In response to detecting the presence of client 504, messaging process 520 checks message history 524 to determine whether any undelivered messages are present for client 504. In this illustrative example, messaging process finds that a message announcing a configuration change is undelivered. In response to this determination, messaging process 520 sends the undelivered message to client 504. In turn, client 504 retrieves configuration data to update configuration settings 506. As a result, configuration settings 506 are now synchronized with the rest of the server data processing systems in the cluster. This type of deployment uses a “push” to deploy updates for configuration settings to the subscribers. A daemon process running on each application server may be used to check message history 524 for changes if a “pull” mechanism is used by client 504.

In this illustrative example, the messaging and updates are handled by a client process, separate from the server process. Of course, the processes in the client may be implemented in the server process. These constructs, as well as the illustration of the other components are presented for purposes of clearly illustrating the mechanism of the present invention and not intended as limitation in which the processes illustrated may be implemented. For example, the process of the present invention may be implemented in other components or combination of components.

FIG. 6 is a flowchart of a process for identifying configuration changes using a durable subscription is depicted in accordance with a preferred embodiment of the present invention. The process illustrated in FIG. 6 may be implemented in a data processing system, such as server data processing system 508 in FIG. 5.

The process begins by a deployment manager listening for new configuration changes (step 600). When a configuration change is present, the process receives configuration data (step 602). This data is received through an interface such as a web based interface, a command line interface, or some other interface. The process pushes configuration changes to subscribing clients (step 604). For example, step 604 may be used to configure a data source on all the servers participating in a server cluster. The deployment manager pushes the configuration change to configure the data source on the subscribing clients. Next, a determination is made as to whether the change is complete (step 606). In step 606, the change is considered complete if all of the clients have received and made the configuration change. The process receives an acknowledgement from clients to indicate that the change has been completed. If an acknowledgement is not received, then the change is assumed to not have been completed. The process checks for more work (step 608) with the process returning to step 600 to listen for more new configuration changes. In step 608, a check is made by determining if new changes are present to be made.

Turning back to step 606, if a complete change is not present, the process reports the error (step 610), with the process terminating thereafter.

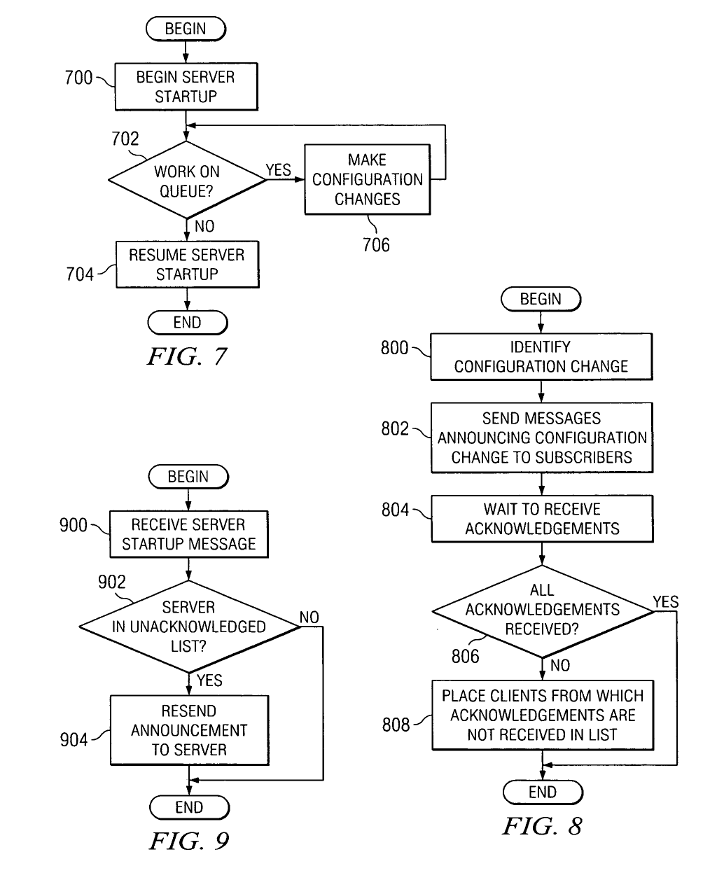

Next, FIG. 7 is a flowchart of a process for checking for configuration changes upon startup in accordance with a preferred embodiment of the present invention. The process illustrated in FIG. 7 may be implemented in a data processing system, such as server data processing system 508 in FIG. 5. More specifically, the process in these illustrative examples may be implemented in a client, such as client 504 in FIG. 5.

The process begins with a server startup (step 700). Next, a determination is made as to whether the work is present on the queue (step 702). In this example, the work queue resides on the client and houses changes. In step 702, the determination is made by determining whether a notification has been received from the subscription service that indicates work, such as a configuration change is present. If the work is not present on the queue, the server resumes startup (step 704) with the process terminating thereafter. With reference again to step 702, if work resides on the queue, the process makes the configuration changes (step 706), with the process returning to step 702.

FIGS. 8 and 9 illustrate messaging used to ensure configuration settings in servers remain synchronized. The processes depicted in these figures employ a durable subscription system to maintain settings in a guaranteed state for a group of servers, such as those in a cluster. FIG. 8 is a flowchart of a process for announcing and disseminating configuration changes in accordance with a preferred embodiment of the present invention. The process in FIG. 8 may be implemented in a deployment system, such as deployment manager 500 in FIG. 5. More specifically, the process may be implemented in messaging process 520 in FIG. 5.

The process begins by identifying a configuration change (step 800). The process sends messages, announcing the configuration change, to the subscribers (step 802). In step 802, the process sends multiple messages to the subscribers with one message being sent to each subscriber regarding the configuration change. In step 802, the recipients for the message are selected using a subscription list, such as subscription list 522 in FIG. 5. The process then waits to receive acknowledgements of receipt to the configuration change messages (step 804). In step 804, the amount of time the process waits depends on the implementation.

Next, a determination is made as to whether all acknowledgements have been received (step 806). If not all acknowledgments have been received, the process places any clients from which acknowledgements have not been received in the list (step 808), with the process terminating thereafter. The process also terminates in step 806 when all of the acknowledgements have been received.

FIG. 9 is a flowchart of a process for resending messages in accordance with a preferred embodiment of the present invention. The process in FIG. 9 may be implemented in a deployment system, such as deployment manager 500 in FIG. 5. More specifically, the process may be implemented in messaging process 520 in FIG. 5.

The process begins by receiving a server startup message (step 900). This message is used to indicate that a server that may have been previously unavailable is now available to receive messages. In another example, the process may ping a server at different intervals to determine if that server is now available. Next, a determination is made as to whether the server is on an unacknowledged list (step 902). In these examples, the lack of acknowledgements is stored in a data structure, such as message history 524 in FIG. 5. If the server is present on the unacknowledged list, the process resends pending configuration change announcements to that server (step 904), with the process terminating thereafter. The process also terminates in step 902 is the server is not present in the unacknowledged list.

Thus the present invention provides an improved method, apparatus, and computer instructions for managing configuration settings in a set of servers. The mechanism of the present invention involves identifying servers that do not acknowledge an announcement for a configuration change. When a server is later available, that announcement is resent to the server with the server then updating its configuration settings. In this manner, the mechanism of the present invention allows for automatic resynchronization of a server's configuration settings when the server starts up or becomes available.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. In these examples, configuration settings are maintained for servers in a cluster. The mechanism of the present invention may also be applied to any grouping of servers or other data processing systems, logical or physical. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method in a data processing system for updating configuration settings, the method comprising:
responsive to starting an application server in the data processing system, contacting a messaging system to determine whether a configuration change occurred while the application server was unavailable to update configuration settings; and
responsive to a determination that the configuration change occurred, receiving configuration data to implement the configuration change, wherein the configuration setting for the application server are updated.

2. The method of claim 1, wherein the messaging system is a durable subscription messaging system.

3. The method of claim 1, wherein the configuration data is located on a remote data processing system.

4. The method of claim 1, wherein the data processing system is part of a server cluster.

5. The method of claim 1, wherein the contacting step comprises:
sending an indication that the application server is present to the messaging system, wherein the messaging system returns a message indicating that the configuration change has occurred while the application server was inactive.

6. A method in a data processing system for updating configuration settings in an application server in a server cluster, the method comprising:
responsive to a presence of a configuration change, sending messages to a set of application servers;
responsive to an inability to deliver a message to the application server, saving the message to form a saved message;
responsive to subsequently detecting a presence of the application server, sending the saved message to the application server; and
sending configuration data to the application server, wherein the application server uses the configuration data to perform the configuration change, wherein the configuration settings in the application server are updated.

7. The method of claim 6, wherein the method is performed by a deployment manager.

8. A computer program product in a computer readable medium for updating configuration settings, the computer program product comprising:
first instructions, responsive to starting an application server in a data processing system, for contacting a messaging system to determine whether a configuration change occurred while the application server was unavailable to update configuration settings; and
second instructions, responsive to a determination that the configuration change occurred, for receiving configuration data to implement the configuration change, wherein the configuration settings for the application server are updated.

9. The computer program product of claim 8, wherein the messaging system is a durable subscription messaging system.

10. The computer program product of claim 8, wherein the configuration data is located on a remote data processing system.

11. The computer program product of claim 8, wherein the data processing system is part of a server cluster.

12. The computer program product of claim 8, wherein the first instructions comprises:
sub instructions for sending an indication that the application server is present to the messaging system, wherein the messaging system returns a message indicating that the configuration change has occurred while the application server was inactive.

13. The computer program product of claim 8, wherein the first instructions and the second instructions are executed by a deployment manager.

14. The computer program product of claim 8, wherein the data processing system is a server data processing system.
